(19) United States
(12) Patent Application Publication
(10) Pub. No.: US 2005/0197854 A1
(43) Pub. Date: Sep. 8, 2005

(54) Method and system for providing a numbering system for identifying conferences

(76) Inventor: Edwin S. Grosvenor, Bethesda, MD (US)

Correspondence Address: DLA PIPER RUDNICK GRAY CARY US LLP, P. O. BOX 9271, RESTON, VA, 20195, US

(21) Appl. No.: 11/050,860

(22) Filed: Feb. 7, 2005

Related U.S. Application Data
(60) Provisional application No. 60/542,429, filed on Feb. 6, 2004.

(51) Int. Cl. G06F 17/60

(52) U.S. Cl. 705/1

(57) ABSTRACT

A method and system for providing a generally-accepted identifier and a database for maintaining meeting identifiers is disclosed. Providing an identifier may include one or more of assigning a conference organizer character sequence designating a conference organizer, assigning a conference character sequence designating a conference operated by the conference organizer, assigning a series character sequence designating a related group of sessions at the conference, and assigning a session character sequence designating a presentation within a series or a conference.

### FIELD OF THE INVENTION

This invention relates generally to the field of registering and identifying meetings. Specifically, this invention relates to a method for identifying conferences and conference sessions.

### BRIEF DESCRIPTION OF THE DRAWINGS

Aspects, features, benefits and advantages of the embodiments of the present invention will be apparent with regard to the following description and the accompanying drawings where:

FIG. 1 depicts an exemplary session identifier according to an embodiment of the present invention.

FIG. 2 depicts an exemplary database of content pertaining to conference sessions identified by the session identifier according to an embodiment of the present invention.

FIG. 3 is a block diagram of exemplary internal hardware that may be used to contain or implement the program instructions of a system embodiment of the present invention.

FIGS. 4-16 depict an exemplary process flow and exemplary screen shots for registering for a session identifier and supplying conference information according to an embodiment of the present invention.

### DETAILED DESCRIPTION OF EMBODIMENTS OF THE INVENTION

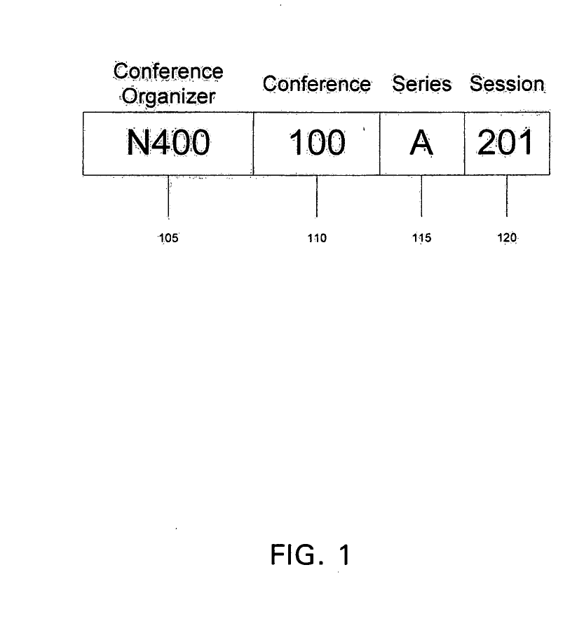

FIG. 1 depicts an exemplary session identifier for identifying, in a generally-accepted manner, written, audio and/or visual content associated with a meeting, according to an embodiment of the present invention. The term meeting is used throughout this document, and may refer to any type of conference, conference session, meeting, convention or get-together, as is evident by the use of these other words throughout the document.

Each conference session is assigned a session identifier that, in a uniquely and generally-accepted manner, identifies the conference. In one embodiment, the conference organizer, conference and session for the conference is identified. The use of such a number permits easy access for individuals when seeking information regarding the meeting.

In an embodiment, a method of providing a unique session identifier for meeting sessions includes assigning one or more codes or fields. The method will be described below in examples where three or four fields are used. However, those experienced in the art will see that any number of codes or fields may be used, and that the codes or fields may be used in any order. For example, the unique session identifier can include a first field having a first length, a second field having a second length, and a third field having a third length. The unique session identifier can then be assigned including the first field, the second field and the third field. A unique session identifier may be assigned by combining in some manner the first field, the second field and the third field. The fields may be filled with any type of characters (e.g., alphanumeric characters).

In an embodiment, the session identifier, also called a conference/meeting industry standard (CMIS) identifier, may include a first field 105, which may designate a conference organizer. A conference organizer may include, without limitation, a trade association, a professional organization, a trade union, a membership organization, a trade show organizer, a non-profit organization, a university, a government agency, a business or any combination thereof. Each conference organizer may be assigned a unique character sequence in the first field 105. The unique character sequence may be assigned to a meeting session that has been presented, is currently being presented, or will be presented at a conference operated by the conference organizer. The unique character sequence may assist a person in finding content presented at conferences operated by the conference organizer if the person searches a database using the conference organizer number.

In an embodiment, the session identifier may include a second field 110, which may designate a conference operated by the conference organizer designated in the first field 105. A conference may include, without limitation, a trade show, a scholarly conference, an exposition, a stockholder's meeting, or any other conference. Each conference operated by a conference organizer may be assigned a unique character sequence in the second field 110. The unique character sequence may be assigned to a meeting session that has been presented, is currently being presented, or will be presented at the conference. The unique character sequence may assist a person in finding content presented at the conference if the person searches a database using the unique conference organizer and conference character sequences.

In an embodiment, the session identifier may include a third field 115, which may designate a series of related sessions presented at a conference designated in the second field 110 organized by the conference organizer designated in the first field 105. A series may include a group of sessions on a related topic that are presented at the same conference. Each series at a conference operated by a conference organizer may optionally be assigned a unique character sequence in the third field 115. The unique character sequence may be assigned to a meeting session that has been presented, is currently being presented, or will be presented within the series. The unique character sequence may assist a person in finding content presented in the series if the person searches a database using the unique conference organizer, conference and series character sequences.

In an embodiment, the session identifier may include a fourth field 120, which may designate a session at the conference designated by the second field 110 organized by the conference organizer designated in the first field 105. The session may optionally be a session of a series designated by the third field 115. A session may include any single presentation including, without limitation, a keynote speaker presentation, a paper presentation, a chairman's report, a new product presentation, and the like. Each session within a series at a conference operated by a conference organizer may be assigned a unique character sequence in the fourth field 120. The unique character sequence may be assigned to a meeting session that has been presented, is currently being presented, or will be presented. The unique character sequence may assist a person in finding content presented during the session if the person searches a database using the unique conference organizer, conference, series and session character sequences.

In an embodiment, the session identifier may include a location field which designates a Venue Address Number (“VAN”). The VAN may be attached as a suffix to indicate the location of the conference or meeting (e.g., building and room number). The VAN uniquely identifies conference and meeting venues at such locations as convention centers, conference centers, hotels with meeting rooms, universities, associations, large law firms, corporate facilities, etc.

In an embodiment, the session identifier may include a content medium field, which indicates the medium of materials related to the session (e.g., webcast, handout, audiotape).

The session identifier may optionally be the concatenation of the first field 105, the second field 110, the third field 115 and the fourth field 120. Alternatively, the session identifier may be the concatenation of the first field 105, the second field 110 and the fourth field 120. In addition, other fields may be appended to the session identifier, such as a country code field, a location field, a content medium field (to describe products associated with a meeting), and other identifying fields. These fields may be in any order. The session identifier may also incorporate fewer fields. Thus, any number of any type of fields may make up the session identifier. All of these embodiments are within the scope of the description contained herein.

In an embodiment, the session identifier may be affixed to a tangible article or packaging for a tangible article to designate the conference session to which the tangible article pertains. For example, the tangible article may include a white paper, course handout, workbook and/or other material. Assigning and/or affixing the session identifier to the tangible article or a related group of tangible articles may include processing a fee.

In addition, the session identifier may be assigned to an audio and/or visual content file, such as an audiocassette, a videocassette, a streaming video file, a webcast, a digital or analog cable television broadcast, and/or a satellite television broadcast. The session identifier may be incorporated into the audiovisual content file in the form of metadata. It may appear in the audiovisual content itself, or in the case of distributed materials it may be on a label affixed to the recording media and/or packaging. Assigning the session identifier to the audiovisual content file may include processing a fee.

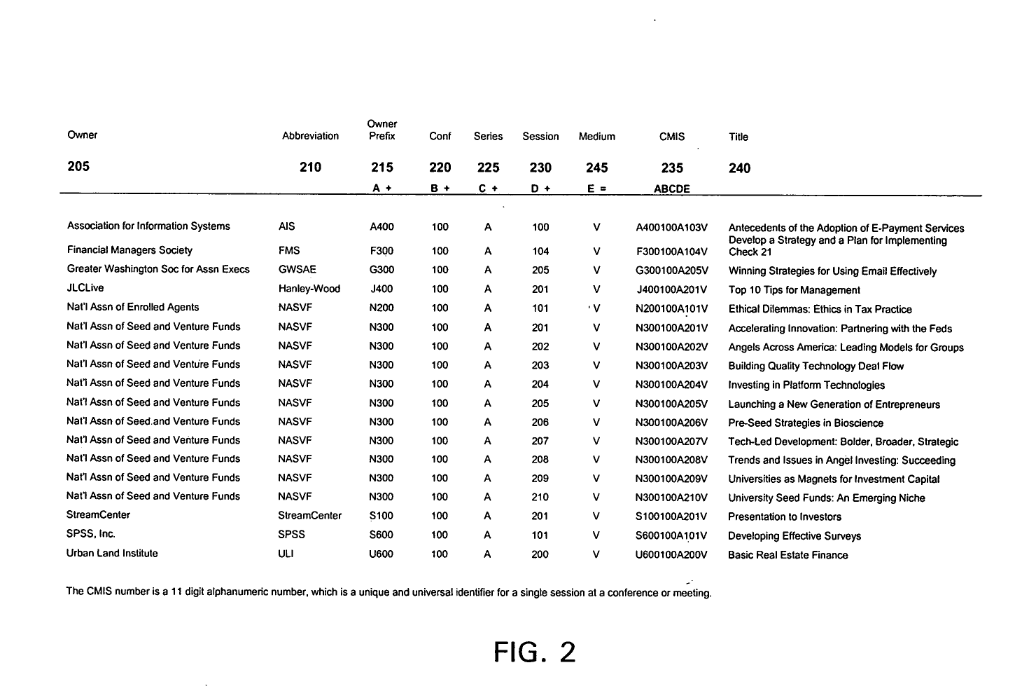

FIG. 2 depicts an exemplary database of content pertaining to meeting sessions identified by the session identifier according to an embodiment of the present invention. The database may maintain a number of fields related to each meeting session including, without limitation, the name of the conference organizer 205, an abbreviated name for the conference organizer 210, the conference organizer character sequence 215, the conference character sequence 220, the series character sequence 225, the session character sequence 230, the unique session identifier 235 for the content file, and the title 240 of the session. Additionally, a product field 245 may be included.

The unique session identifier 235 for the content file may be the concatenation of the conference organizer character sequence 215, the conference character sequence 220, the series character sequence 225, and the session character sequence 230. The title 240 for the session may be used to provide information regarding the subject matter of the session. Moreover, the title 240 may be used to assist a person in finding content or products pertaining to the meeting session if they are searching the database.

The information contained in the product field 245 may depend upon the product to be offered. The product field 245 may include a file location for a content file containing an audiovisual recording of the meeting session that may be downloaded. In this case, the product field 245 may be used by a computer system to access the content file after a person has selected it for display. Alternatively, the product field 245 may provide information regarding how to order one or more products, such as an audio cassette, a video cassette or a transcript of the meeting session, PowerPoint® slides from the session, or any other product associated with the session.

One of skill in the art will realize that a database having identifiers with more or fewer fields may be created. In addition, the fields of the identifiers may be arranged in the sequence shown in FIG. 1, or in a different sequential order. It is intended that all such databases and identifiers be within the scope of the invention, which is not limited to the exemplary embodiment of the database described above.

In an embodiment, the database may provide, for each session identifier, a file identifier providing a link to an audiovisual content file, a variable denoting whether the audiovisual content file to which the session identifier corresponds may be accessed, and a price for accessing the audiovisual content file. In an embodiment, the database further includes, for each session identifier, a variable denoting whether a discount price exists for one or more groups of people, and the discount price for accessing the audiovisual content file. In an embodiment, the database further includes, for each session identifier, a means of authentication for accessing the audiovisual content file.

In an embodiment, a processor, and a computer-readable medium may be operatively coupled to the processor. The computer-readable medium may contain a database with one or more entries. Each entry may include a session identifier, a file identifier denoting an audiovisual content file, and a link used to access the audiovisual content file.

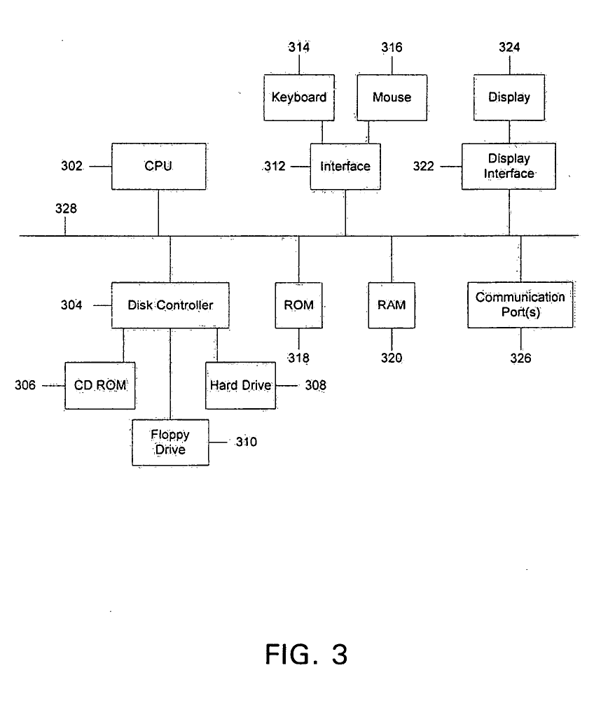

FIG. 3 is a block diagram of exemplary internal hardware that may be used to contain or implement the program instructions of a system embodiment of the present invention. Referring to FIG. 3, a bus 328 serves as the main information highway interconnecting the other illustrated components of the hardware. CPU 302 is the central processing unit of the system, performing calculations and logic operations required to execute a program. Read only memory (ROM) 318 and random access memory (RAM) 320 constitute exemplary memory devices.

A disk controller 304 interfaces with one or more optional disk drives to the system bus 328. These disk drives may be external or internal floppy disk drives such as 310, CR ROM drives 306, or external or internal hard drives 308. As indicated previously, these various disk drives and disk controllers are optional devices.

Program instructions may be stored in the ROM 318 and/or the RAM 320. Optionally, program instructions may be stored on a computer readable medium such as a floppy disk or a digital disk or other recording medium, a communications signal or a carrier wave.

An optional display interface 322 may permit information from the bus 328 to be displayed on the display 324 in audio, graphic or alphanumeric format. Communication with external devices may optionally occur using various communication ports such as 326.

In addition to the standard computer-type components, the hardware may also include an interface 312 which allows for receipt of data from input devices such as a keyboard 314 or other input device 316 such as a remote control, pointer and/or joystick.

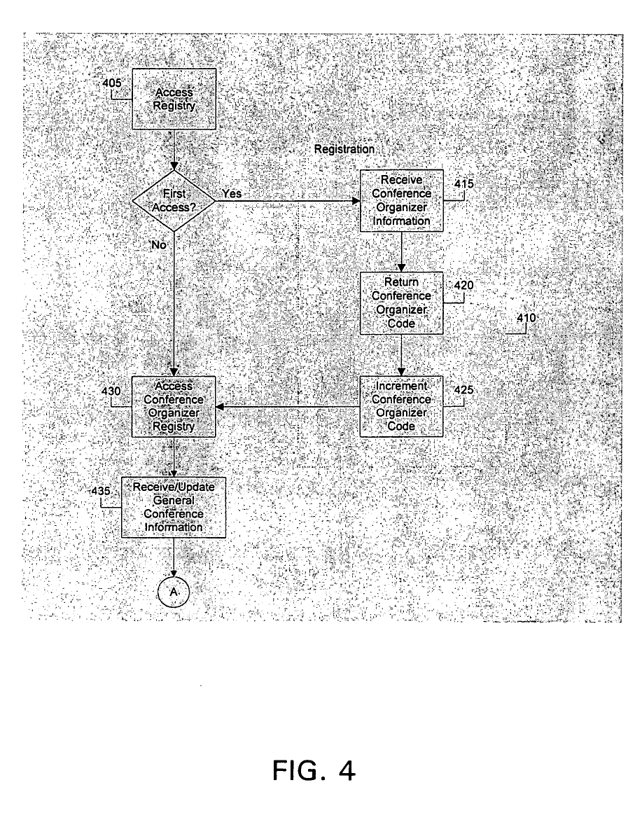

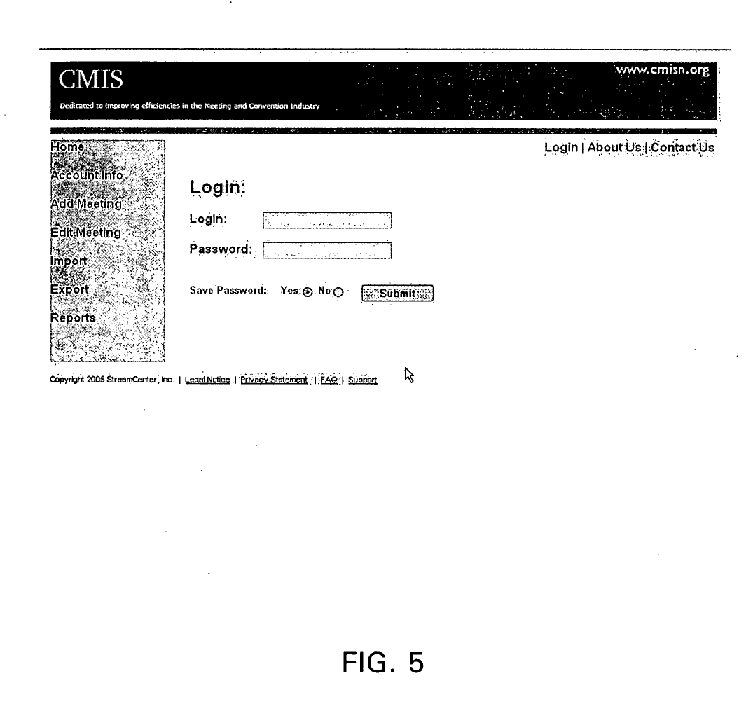

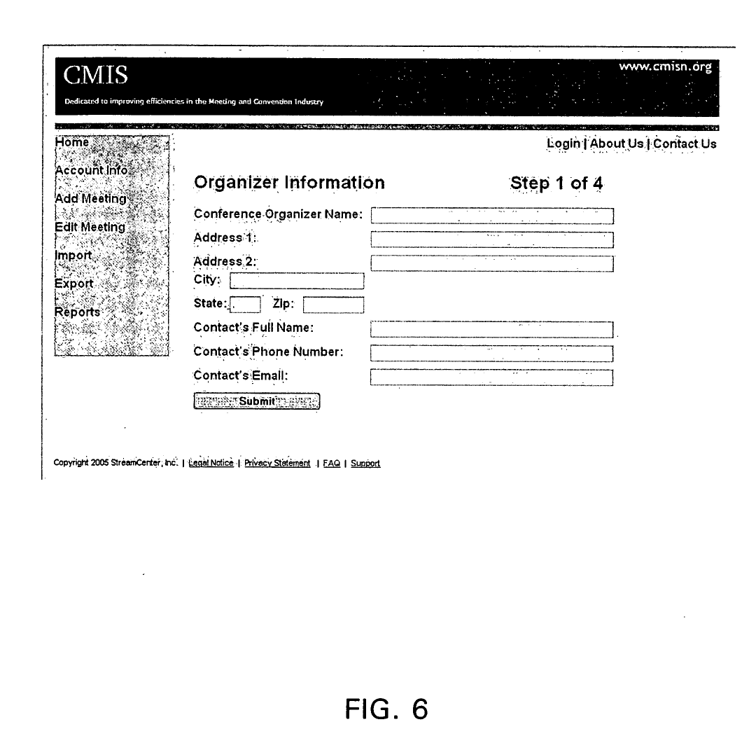

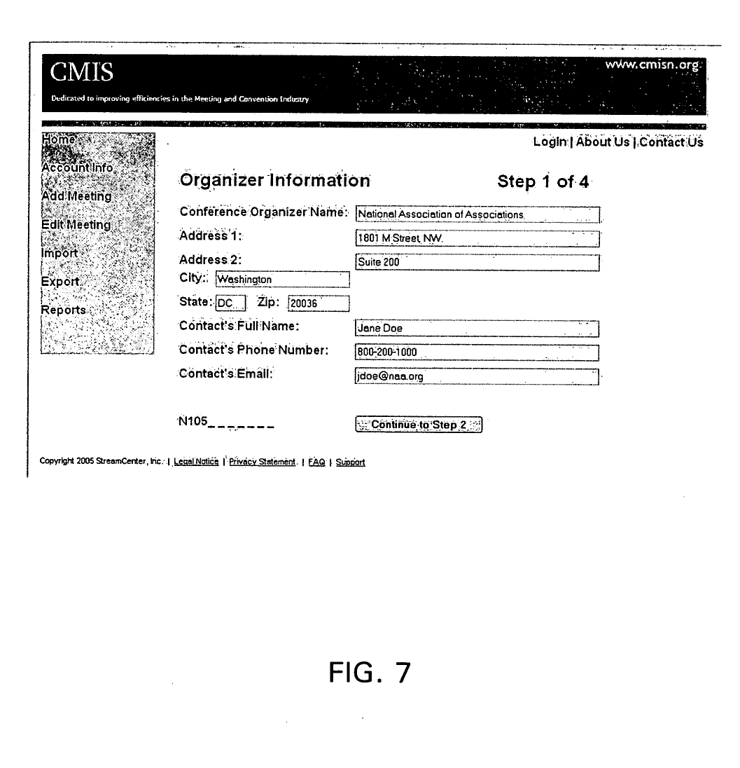

FIGS. 4-16 depict an exemplary process flow and sample screen shots for registering for a session identifier and supplying conference information according to an embodiment of the present invention. Referring to FIG. 4, a conference organizer may access 405 a session identifier registry system. Preferably, the session identifier registry system may be located on a publicly accessible website that is maintained by a registrar. Alternate embodiments may include, for example, a thin-client interface, a dumb terminal connected to a server, a telephone-to-computer interface, or a single computer interface. FIG. 5 is an exemplary screen shot illustrating a login page, according to one embodiment of the invention. If the conference organizer is accessing the registry system for the first time, the conference organizer may register 410 with the system. Registration may request 415 the entry of, for example, the name and address of the conference organizer and may return 420 a conference organizer code. FIGS. 6 and 7 are exemplary screen shots illustrating a registration page, according to one embodiment of the invention. The conference organizer code may represent the first field 105 of the session identifier for all session identifiers pertaining to the conference organizer. Each time a new conference organizer access the database, the assigned conference organizer code may increment 425 by, for example, one. In this manner, each conference organizer receives a unique conference organizer code. Preferably, the conference organizer may use the assigned conference organizer code and/or the conference organizer's name to access 405 the registry after the initial registration process.

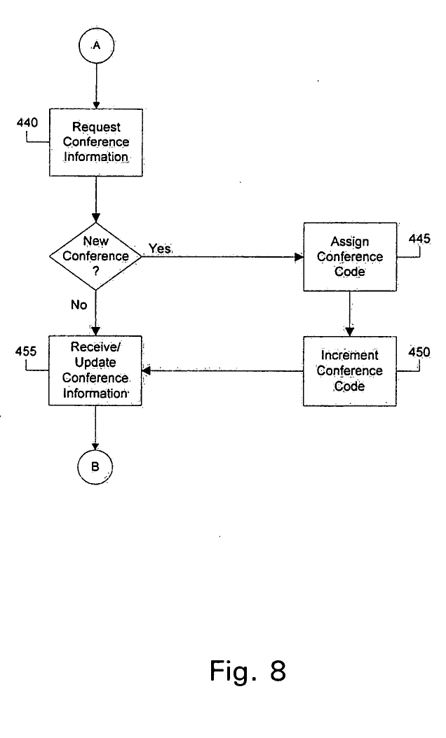

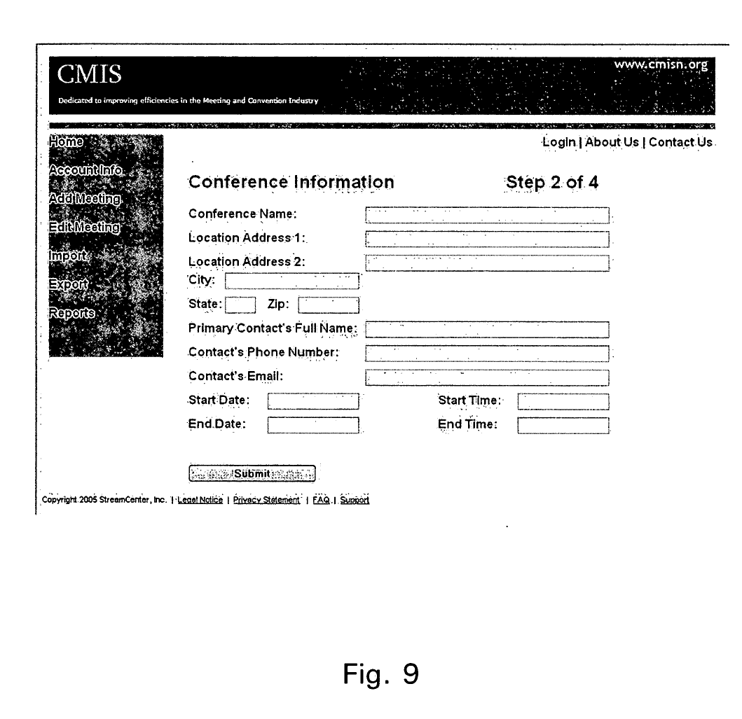

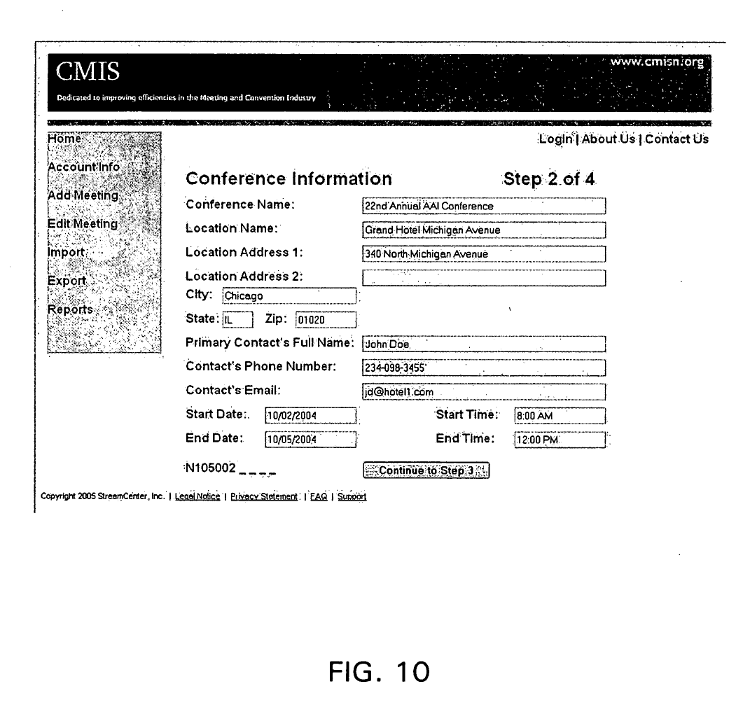

At any point after receiving a conference organizer code, the conference organizer may enter 430 the registry system. The conference organizer may enter 435 information regarding the general subject matter of conferences presented by the conference organizer. For example, if the American Medical Association is a conference organizer, the subject matter may be medicine. Referring to FIG. 8, the registry system may also prompt 440 the conference organizer to supply information regarding particular conferences organized by the conference organizer. FIGS. 9-10 are exemplary screen shots illustrating a requested information page, according to one embodiment of the present invention. The first time that a conference organizer enters information regarding a particular conference, the conference may be assigned 445 a conference code equal to, for example, zero. Preferably, the conference code may correspond to the second field 110 of the session identifier described above. For each subsequent conference for which the conference organizer enters information, the conference code may be incremented 450. In this manner, the conference organizer may assign a unique conference code to each conference.

For each conference, the conference organizer may enter 455 information including, without limitation, a conference title, dates for the conference, the subject matter of the conference, and information pertaining to one or more series 460 within the conference or one or more sessions 480 with the conference.

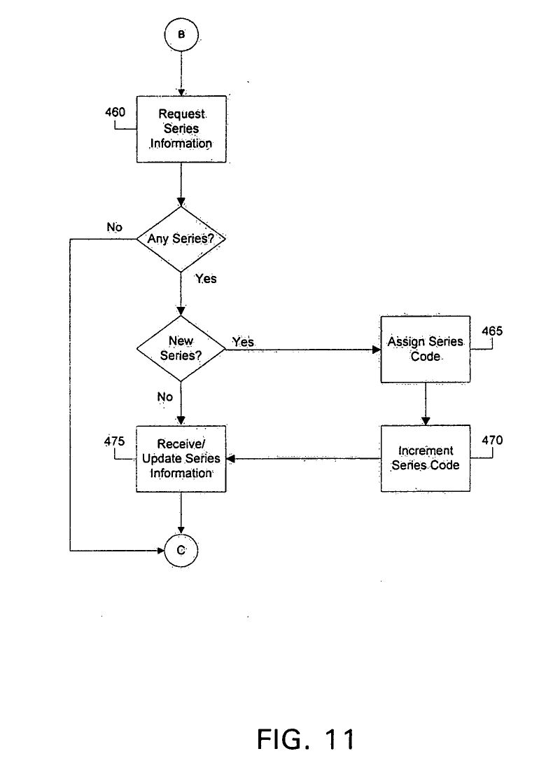

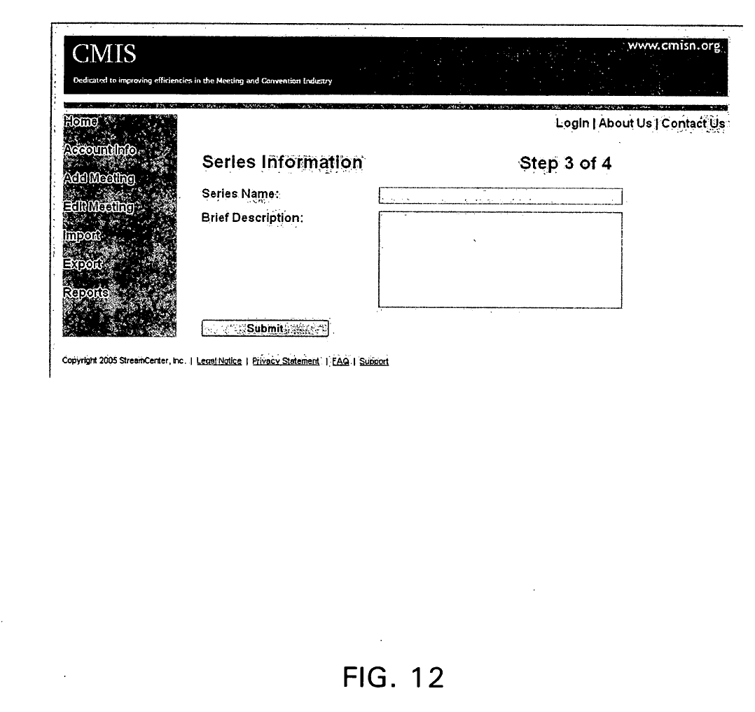

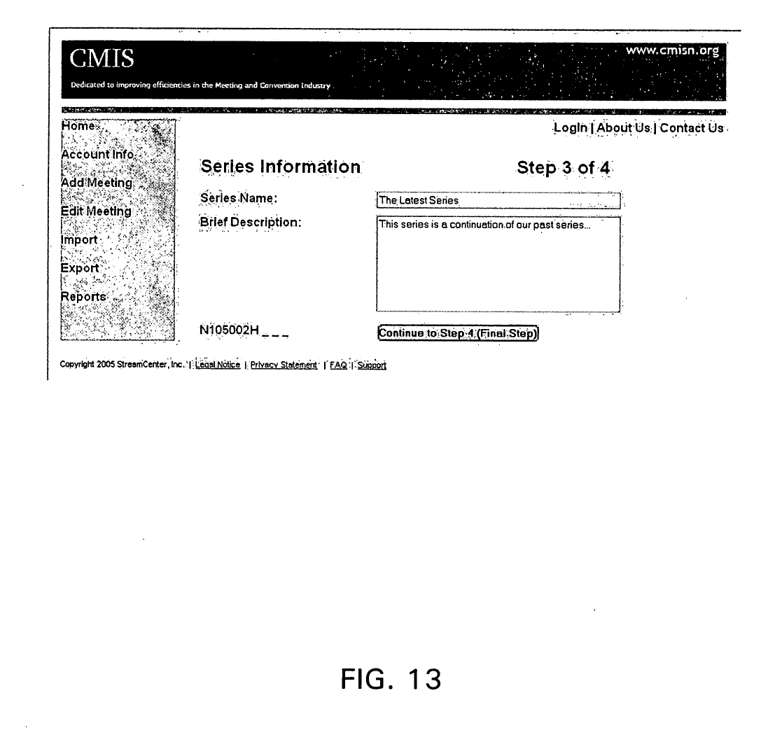

If the conference does not include a series, a series code may be set to an initial value for all sessions within a conference, or no series code may be assigned. Referring to FIG. 11, if a conference includes one or more series, each series may be assigned 465 a series code. The first series in a conference may be assigned an initial value. The registry system may automatically increment 470 each subsequently entered series to the next available value for the series code. When information pertaining to a new conference is entered, the series code may be reset to the initial value. The conference organizer may enter 475 information pertaining to each series, including without limitation, a series title, date for the series, the subject matter of the series and information pertaining to one or more sessions within the series. FIGS. 12-13 are exemplary screen shots illustrating a series information page, according to one embodiment of the present invention.

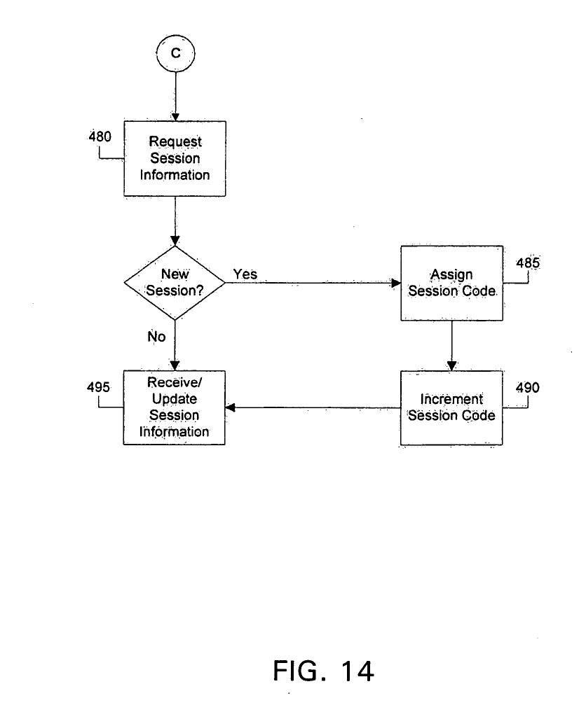

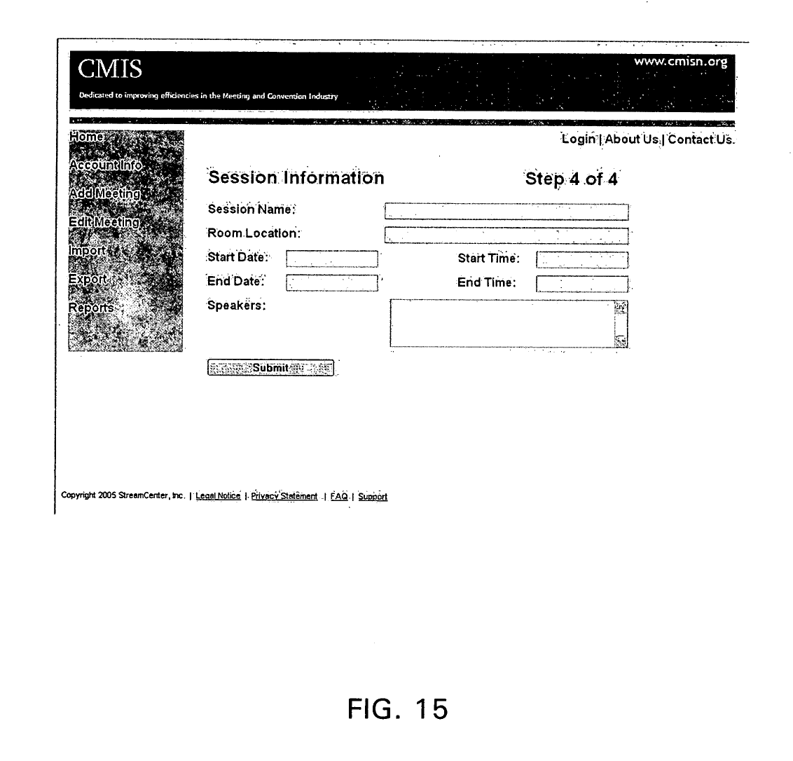

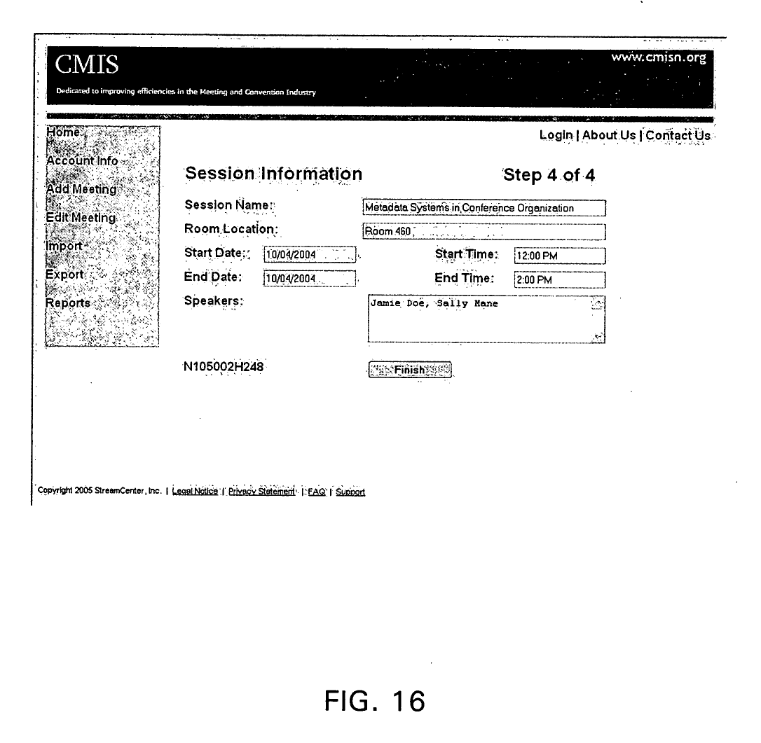

Referring to FIG. 14, each session within a conference or a series may be assigned 485 a session code. The first session in a conference or a series may be assigned an initial value. The registry system may automatically increment 490 each subsequently entered session to the next available value for the session code. When information pertaining to a new conference or series is entered, the session code may be reset to the initial value. The conference organizer may enter 495 information pertaining to each session, including without limitation, a title for the session, the date and time the session is held, the subject matter of the session, biographical information regarding one or more presenters, introducers, moderators or panelists, information regarding presentation materials, and one or more products relating to the session. The products may include, without limitation, some or all of audiocassettes, videocassettes, compact discs, DVDs, downloadable audiovisual content files, or transcripts of the session; hotel listings; apparel; equipment or novelty items associated with the session and/or conference. FIGS. 15-16 are exemplary screen shots illustrating a session information page, according to one embodiment of the invention.

The information entered by conference organizers may be stored in a database. An exemplary database incorporating information from a plurality of conference organizers is depicted in FIG. 2. Such a database may be made publicly available by maintaining the database, for example, on a website.

Any entity (e.g., organization, person) providing a product or service to the conference or conference session can use the identifier. This identifier can be used as a standard identifier by an entire industry, or pieces of an industry. A professional may access the database to obtain information regarding upcoming conferences in an area of interest. As such, the database provides a way for a conference organizer to advertise the conference outside of its normal channels. In addition, the conference organizer may provide information regarding products that individuals may purchase, such as recordings, transcripts or notes of conference sessions. Advertising conferences and products may provide additional revenue streams to the conference organizer by charging a fee to individuals who are interested in the subject matter, but were unaware of or unable to attend the conference.

In an alternate embodiment, the conference organizer may submit information pertaining to one or more conferences to the registrar in an electronic or non-electronic format for entry into the session identifier registry system by the registrar.

The above-described methods can be used for cataloguing meetings, conferences and/or conference sessions held for the purpose of disseminating training and/or continuing professional education; industry research and reports; financial and investment analysis; industry news and education in such fields as health and medicine, information technology and computer science, law, accounting, science and engineering, and agriculture; and/or motivational and “self-help” programs. A system for cataloguing meetings could be used by, for example, the hotel, motel and lodging industry to identify conferences and meetings requiring rooms, meeting space, catering services and the like.

In an embodiment, a centralized database is provided that enables individuals to search for conferences addressing subject matters of interest. An updatable registry system in which information regarding upcoming meetings is made accessible to organizers, vendors, meeting attendees, and other stakeholders. The system of numbering meetings may permit conference organizers, vendors and customers to communicate and share information; eliminate inefficiencies and reduce confusion and duplication of work; increase utilization of the intellectual and economic resources represented by the tens of thousands of meetings held each year; and improve international economic and scientific cooperation led by organizations based in the United States.

In an embodiment, a Convention and Meeting Industry Standard (CMIS) Number may be administered by an organization exclusively devoted to assigning the number and managing registrations, advising organizations on the correct and proper usage of the number, informing organizations within the meeting and conference industry of their assignments and identifying ranges, and maintenance of an up-to-date and comprehensive listing of all CMIS assignments for inclusion in print and web-based directories.

In an embodiment, a generally-accepted system of numbering meetings may allow organizers and other vendors to identify education content associated with specific meeting sessions such as webcasts and educational videos, audio recordings, and white papers.

In an embodiment, a method is provided for cataloguing services associated with a meeting. For example, hotels associated with the meeting, caterers for the meeting, restaurants that offer promotions to meeting goers, meeting spaces associated with meeting sessions, and the like may each be associated with the session identifier in order to permit easy access to promotional advertising and reservation information for meeting attendees.

In further embodiments, the method includes processing a fee for assigning the unique session identifier to meetings and/or affixing the unique session identifier on a commercial article relating to the meeting.

Although the invention has been described with reference to the preferred embodiments, it will be apparent to one skilled in the art that variations and modifications are contemplated within the spirit and scope of the invention. The description of the embodiments are made by way of example rather than to limit the scope of the invention, and it is intended to cover within the spirit and scope of the invention all such changes and modifications. It must also be noted that as used herein and in the appended claims, the singular forms “a,” “an,” and “the” include plural references unless the context clearly dictates otherwise. Thus, for example, reference to a “character sequence” is a reference to one or more character sequences and equivalents thereof known to those skilled in the art, and so forth. Any methods, materials, and devices similar or equivalent to those described herein can be used in the practice or testing of embodiments of the present invention.

In addition, it should be understood that the Figures described above, which highlight the functionality and advantages of the present invention, are presented for example purposes only. The architecture of the present invention is sufficiently flexible and configurable, such that it may be utilized in ways other than that shown in the Figures.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope of the present invention in any way.

1. A method, comprising:
generating one or more codes, wherein at least one code designates a session at a conference; and
assigning a generally-accepted session identifier identifying the session and including the one or more codes;
wherein the session is one of a plurality of sessions, the plurality of sessions comprising non-related sessions or organized by non-related organizations.

2. The method of claim 1 wherein generating one or more codes comprises:
assigning a first code having a first length, wherein each value for the first code designates a different conference organizer;
assigning a second code having a second length, wherein each value for the second code designates a different conference operated by the conference organizer designated by the first code; and
assigning a third code having a third length, wherein each value of the third code designates a different session at the conference designated by the second code.

3. The method of claim 2 wherein assigning a session identifier comprises combining the first code, the second code and the third code.

4. The method of claim 2 wherein the first length is 4 characters, the second length is 3 characters, and the third length is 3 characters.

5. The method of claim 2 wherein the first code, the second code and the third code are each alphanumeric.

6. The method of claim 1, wherein generating one or more codes comprises:
assigning a first code having a first length, wherein each value for the first code designates a different conference organizer;
assigning a second code having a second length, wherein each value for the second code designates a different conference operated by the conference organizer designated by the first code; and
assigning a third code having a third length, wherein each value for the third code designates a different series at a conference designated by the second code.
assigning a fourth code having a fourth length, wherein each value of the fourth code designates a different session of the series designated by the third code.

7. The method of claim 6 wherein assigning the session identifier comprises combining the first code, the second code, the third code and the fourth code.

8. The method of claim 7 wherein the first length is 4 characters, the second length is 3 characters, the fourth length is 1 character and the third length is 3 characters.

9. The method of claim 7 wherein the first code, the second code, the third code and the fourth code are each alphanumeric.

10. The method of claim 1, further comprising:
processing a fee for assigning the session identifier to the session.

11. The method of claim 1, further comprising assigning the session identifier to a commercial article related to the session.

12. The method of claim 11, further comprising processing a fee for affixing the session identifier to the commercial article.

13. A method, comprising:
receiving a plurality of generally-accepted session identifiers each corresponding to a session of a conference; and
storing the plurality of generally-accepted session identifiers in a database,
wherein each generally-accepted session identifier comprises one or more codes, wherein at least one code designates a session at a conference;
wherein the plurality of session identifiers comprise session identifiers identifying non-related conferences or organized by non-related organizations.

14. The method of claim 13, wherein the one or more codes comprise:
a first code, wherein each value for the first code designates a different conference organizer;
a second code, wherein each value for the second code designates a different conference operated by the conference organizer designated by the first code; and
a third code, wherein each value for the third code designates a different session at the conference designated by the second code.

15. The method of claim 13 wherein the one or more codes comprise:
a first code, wherein each value for the first code designates a different conference organizer;
a second code, wherein each value for the second code designates a different conference operated by the conference organizer designated by the first code;
a third code, wherein each value for the third code designates a different series at the conference designated by the second code; and
a fourth code, wherein each value for the fourth code designates a different session of the series designated by the third code.

16. The method of claim 13 wherein the database further comprises, for each session identifier:
a file identifier denoting a location of an audiovisual content file;
a variable denoting access rights to the audiovisual content file to which the session identifier corresponds; and
a price for accessing the audiovisual content file.

17. The method of claim 16 wherein the database further comprises, for each session identifier:
a variable denoting whether a discounted price exists for one or more groups of people; and
if the variable denotes that a discounted price exists, the discounted price for accessing the audiovisual content file.

18. The method of claim 16 wherein the database further comprises, for each session identifier, a means of authentication for accessing the audiovisual content file.

19. The method of claim 13 wherein the database further comprises, for each session identifier, product information relating to one or more commercial articles to which the session identifier has been assigned.

20. The method of claim 19, wherein the one or more commercial articles comprise:
an audiocassette of the session;
a videocassette of the session;
a transcript of the session;
one or more slides presented at the session;
biographical information regarding one or more presenters for the session; or
one or more creative works composed or edited by one or more of the presenters for the session;
or any combination thereof.

21. A system, comprising:
a processor; and
a computer-readable storage medium operatively coupled to the processor,
wherein the computer-readable storage medium contains a database with one or more entries, each entry comprising:
a generally-accepted session identifier, wherein the generally-accepted session identifier comprises one or more codes, wherein at least one code designates a session at a conference;
wherein the session is one of a plurality of sessions comprising non-related sessions or organized by non-related organizations.

22. A method, comprising:
maintaining a last-assigned conference organizer value;
maintaining a first list of entries pertaining to one or more conference organizers comprising non-related conference organizers that have been assigned conference organizer values;
receiving conference organizer information from a conference organizer;
comparing the conference organizer information with one or more entries of the first list; and
if the conference organizer information does not pertain to a conference organizer on the first list, incrementing the last-assigned conference organizer value, assigning the incremented conference organizer value to the conference organizer, adding the conference organizer to the first list, and setting a last-assigned conference value to a first initial value.

23. The method of claim 22 wherein the conference organizer information comprises a name of a conference organizer.

24. The method of claim 22 wherein the conference organizer information comprises a conference organizer value.

25. The method of claim 22, further comprising:
receiving conference organizer data including one or more of a name of the conference organizer and a subject matter for conferences organized by the conference organizer; and
storing the conference organizer data in a database indexed by a conference organizer value.

26. The method of claim 22, further comprising, for each conference organizer:
maintaining the last-assigned conference value;
maintaining a second list of entries pertaining to one or more conferences that have been assigned conference values;
receiving conference information pertaining to a conference;
comparing the conference information with one or more entries of the second list; and
if the conference information does not pertain to a conference on the second list, incrementing the last-assigned conference value, assigning the incremented conference value to the conference, adding the conference to the second list, and setting a last-assigned series value to a second initial value.

27. The method of claim 26 wherein the conference information comprises a name of a conference.

28. The method of claim 26 wherein the conference information comprises a conference value.

29. The method of claim 26, further comprising:
receiving conference data including one or more of a name of the conference, dates for the conference, and the subject matter of the conference; and
storing the conference data in a database indexed by the conference organizer value and the conference value.

30. The method of claim 26, further comprising, for each conference:
maintaining the last-assigned series value;
maintaining a third list of entries pertaining to one or more series that have been assigned series values;
receiving series information pertaining to a series of a conference;
comparing the series information with one or more entries of the third list; and
if the series information does not pertain to a series on the third list, incrementing the last-assigned series value, assigning the incremented series value to the series, adding the series to the third list, and setting a last-assigned session value to an third initial value.

31. The method of claim 30 wherein the series information comprises a name of a series.

32. The method of claim 30 wherein the series information comprises a series value.

33. The method of claim 30, further comprising:
receiving series data including one or more of a name of the series, dates for the series, and the subject matter of the series; and
storing the series data in a database indexed by the conference organizer value, the conference value and the series value.

34. The method of claim 30, further comprising, for each series:
maintaining the last-assigned session value;
maintaining a fourth list of entries pertaining to one or more sessions that have been assigned session values;
receiving session information pertaining to a session;
comparing the session information with one or more entries of the fourth list;
if the session information does not pertain to a session on the fourth list, incrementing the last-assigned session value, assigning the incremented session value to the session, and adding the session information to the fourth list; and
if the session information pertains to a session on the fourth list, retrieving data regarding the session.

35. The method of claim 34 wherein the session information comprises a name of a session.

36. The method of claim 34 wherein the session information comprises a session value.

37. The method of claim 34, further comprising:
receiving session data including one or more of a name for the session, the date and time the session is held, the subject matter of the session, biographical information regarding one or more presenters, introducers, moderators or panelists, information regarding presentation materials, and one or more products relating to the session; and
storing the conference data in a database indexed by the conference organizer value and the conference value.

38. The method of claim 1, wherein at least one code designates location information of the session.

39. The method of claim 1, wherein at least one code designates medium information of a product or service associated with the session.

40. A method, comprising:
generating one or more codes, wherein at least one code designates a meeting; and
assigning a generally-accepted identifier identifying the meeting and including the one or more codes;
wherein the meeting is one of a plurality of meetings, the plurality of meetings comprising non-related meetings or organized by non-related organizations;
wherein the generally-accepted identifier can be utilized by an entity or an individual seeking information or providing a product or service to the meeting.
